(19) United States
(12) Patent Application Publication
(10) Pub. No.: US 2005/0010756 A1
(43) Pub. Date: Jan. 13, 2005

(54) Granting authorization to access a resource

(75) Inventor: Fabrice Clerc, Blainville sur Orne (FR)

Correspondence Address: COHEN, PONTANI, LIEBERMAN & PAVANE, Suite 1210, 551 Fifth Avenue, New York, NY, 10176, US

(73) Assignee: France Telecom, Paris (FR)

(21) Appl. No.: 10/870,585

(22) Filed: Jun. 17, 2004

(30) Foreign Application Priority Data
Jun. 25, 2003 (FR) 0307655

(51) Int. Cl. G06F 11/30

(52) U.S. Cl. 713/155

(57) ABSTRACT

A method of granting authorization to access a resource, comprising the following steps: connecting a user to an access management center to request that authorization to access a given resource be granted to a third party equipped with a mobile terminal, defining particular conditions governing the access authorization, the user sending coordinates of the third party's mobile terminal to the access management center, the access management center generating access data as a function of the resource and said particular conditions, and sending said access data to the third party's mobile terminal to enable the latter to be identified by an access control device associated with said resource in order to authorize the third party to access that resource.

### BACKGROUND OF THE INVENTION

The invention relates to granting authorization to access a resource, which may be a building, a parking garage, a data processing system, a mailbox, or any other object. The invention is addressed more particularly to persons using mobile telephones to whom it is necessary to deliver temporary or one-off authorization to access a resource.

A problem that the invention attempts to solve is granting a third party temporary authorization to access a resource.

One method known in the art for a user to access certain resources consists in keying a confidential code on a numbered keypad, for example. Thus to confer a right of access on a third party it is sufficient for the user to communicate the confidential code to the third party. This method has a number of drawbacks.

It cannot be used to confer a right where the user controls the period of validity. This is because, once the code is known to a third party, it can be used again, even without the knowledge of the user who granted the right of access.

Neither can it be used to guarantee the third party ongoing right of access in the event of an external event out of the control of the protagonists, for example an inopportune code change by an authority.

Furthermore, there is nothing to prevent an access right of this kind being passed on, intentionally or otherwise, by third parties who are not authorized to do so.

French Patent FR278920 in the name of the present applicant discloses an access control system for delivering electronic access rights with a predetermined validity period to users required by their professional activity to access certain resources to which access is limited.

However, systems of this kind deliver access rights in accordance with predetermined time periods only at the initiative of a specific service provider and to previously authorized users.

Moreover, these systems necessitate the use of dedicated portable means, commonly referred to as an “electronic key”, to receive, transport, and present the access rights.

International patent WO 00/35178 describes a system for controlling access to a resource using a mobile telephone.

However, the system necessitates the maintenance and management of a centralized database to contain the coordinates of authorized users. That system also imposes centralized verification of an identifier sent by the user's mobile telephone.

Thus it is necessary to update the database in the event of loss or theft of the equipment of an authorized user or if the access authorization expires, and this represents a major management workload.

### OBJECT AND SUMMARY OF THE INVENTION

An object of the invention is to alleviate the above drawbacks and to provide a system and a method enabling a user to confer access authorization on a third party in a manner that is controlled, simple, secure and fast.

The above objects are achieved by a method of granting authorization to access a resource, the method comprising the following steps:

connecting a user to an access management center to request that authorization to access a given resource be granted to a third party equipped with a mobile terminal,

defining particular conditions governing the access authorization,

the user sending coordinates of the third party's mobile terminal to the access management center,

the access management center generating access data as a function of the resource and said particular conditions, and

sending said access data to the third party's mobile terminal to enable the latter to be identified by an access control device associated with said resource in order to authorize the third party to access that resource.

This is a simple and secure way for a user to take the initiative to deliver certain resource access facilities to a third party of his choice, provided simply that the third party has a conventional portable terminal.

The particular conditions governing the access authorization may define temporary access or one-off access to the resource.

The connection of the user to the access management center advantageously comprises authentication of the user by said access management center.

The connection of the user to the access management center may advantageously comprise verification by the access management center of a correlation between the resource and the user.

In one particular implementation of the invention, the method may comprise verification by the access management center of the fact that the access control device is able to identify the access data sent by the mobile terminal of the third party.

The access control device preferably identifies the access data by cryptographic means.

In another embodiment of the invention, the method may entail the access management system setting parameters of the access control device in order to establish consistency between the access control device and the access data sent to the third party's mobile terminal.

Identification of the third party by the access control device may be effected using an access control protocol over a connection between the mobile terminal and the access control device.

The invention also provides a system for granting authorization to access a resource, the system comprising:

an access management center for managing a request sent by a user requesting that authorization to access a given resource be granted to a third party equipped with a mobile terminal, the access authorization being governed by particular conditions, and

an access control device associated with said resource for identifying access data on the third party's mobile terminal in order to authorize access of the third party to the resource, said access data being generated by the access management center and sent by that center to the third party's mobile terminal.

The invention also proposes an access management center comprising:

a communications module adapted to receive a request from a user requesting that authorization to access a given resource be granted to a third party equipped with a mobile terminal,

a database containing references of the user and the resource,

a central processing unit adapted to manage the request from the user, and

a generator module adapted to create access data as a function of the resource and particular conditions governing the access authorization.

The invention further proposes an access control device comprising:

a connection module adapted to connect to a mobile terminal,

a verification module adapted to verify access data presented by the mobile terminal, and

a delivery module adapted to deliver access to a resource if the result of the verification effected by the verification module is satisfactory.

The invention also proposes a mobile terminal comprising a control module controlling a storage module and a wireless connection module for presenting an access data, received from the access management center, to an access control device.

The invention also provides a computer management program ready to be implemented in the access management center, wherein said program comprises instruction codes for the execution of a management step of the request from the user when said program is executed by the access management center.

The invention further provides a computer control program ready to be implemented in the access control device, wherein said program comprises instruction codes for the execution of a step of verification of the access data presented by the mobile terminal, for delivering access to a resource when said program is executed by the access control device.

The invention also provides a computer processing program ready to be implemented in the control module of the mobile terminal according to claim 15, wherein said program comprises instruction codes for the execution of a management step of the storage and the wireless connection modules for presenting an access data to the access control device when said program is executed by the control module of the mobile terminal.

### BRIEF DESCRIPTION OF THE DRAWINGS

Other features and advantages of the invention will emerge on reading the following description, which is given by way of illustrative and non-limiting example and with reference to the appended drawings, in which:

FIG. 1 is a highly diagrammatic general view of a system of the invention for granting authorization to access a resource;

FIG. 2 is a highly diagrammatic view showing steps of a method of the invention of granting authorization to access a resource; and

FIG. 3 is a highly diagrammatic view showing certain components from FIG. 1 in more detail.

### DETAILED DESCRIPTION OF EMBODIMENTS

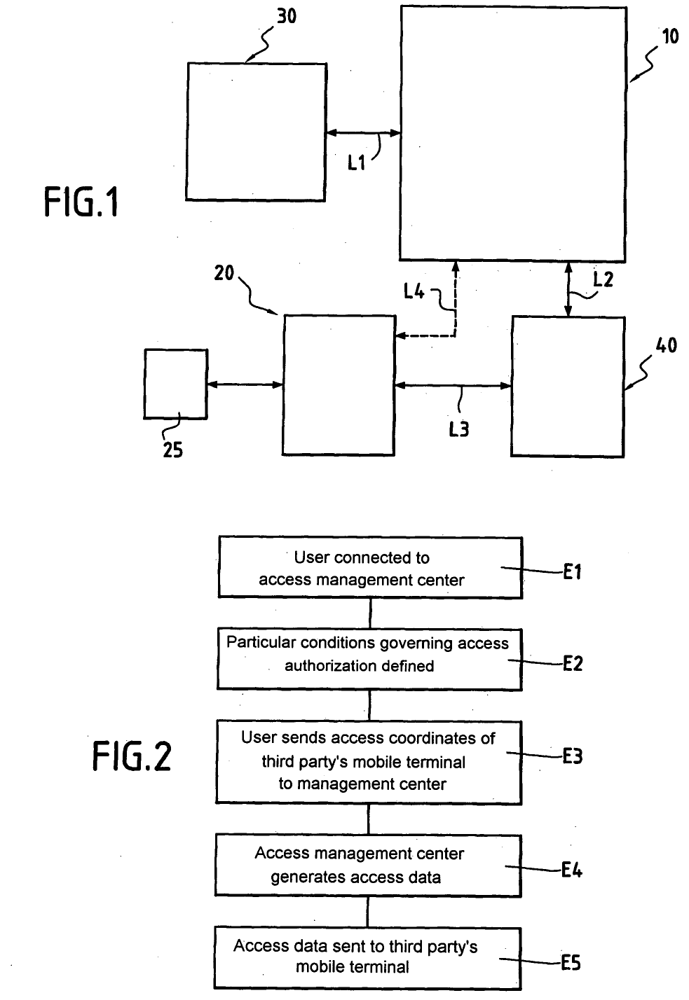

FIG. 1 shows very diagrammatically a system in accordance with the invention for granting access authorization, the system comprising an access management center 10 and an access control device 20 associated with a resource 25.

The access management center 10 processes a request sent by a user by means of a user terminal 30 and requesting that authorization to access a given resource 25 be granted to a third party equipped with a mobile terminal 40, in such a way that the access authorization is governed by particular conditions.

The access control device 20 identifies the third party in order to authorize that party to access the resource 25 using access data that the access management center 10 has sent to the third party's mobile terminal 40.

The term “user” means any person who is a subscriber of a telecommunications operator offering a service corresponding to the subject matter of the present invention. In other words, a user is a person who is recognized and identified by the access management server 10 as being a subscriber of the center.

To become users, people must subscribe to the service beforehand, indicating their identity, their coordinates, the characteristics of the resource(s) 25, which for this purpose are provided with access control devices 20, and a right of access that they require to be able to confer on a third party, provided that this is authorized, which the service verifies beforehand.

For example, verification by cross-checking consistent information may be envisaged, such as the user's telephone number, electronic address, mailing address, and the references of the resource 25. For example, if the resource is a car park with an automatic barrier, it must be the car park of the user's home address.

Verification by validation of the characteristics of the request from the user by an agent trusted by the service may also be envisaged. The agent may be a residents' committee or a doorman of the user's home address, for example.

The method of the invention comprises a plurality of steps, as shown in FIG. 2, that must be executed each time that the user requires to grant a third party authorization to access a resource 25.

First of all (step E1), the user enters into communication with the access management center 10 in order to send a request for granting authorization to access a given resource 25 to a third party equipped with a mobile terminal 40.

Although this is not limiting on the invention, the user communicates with the access management center 10 by means of a connection L1 that may be a telephone connection or an Internet connection.

This connection advantageously includes authentication of the user by the access management center 10.

If the user is using a mobile or fixed telephone, the user may be authenticated by verifying the telephone number.

Similarly, if the user is using an Internet connection, the user may be authenticated by verifying the electronic address.

For improved security, authenticating the user by means of a confidential code entered by the user on a keypad of a terminal 30 may also be envisaged.

The user may be authenticated by voice authentication or by a DTMF token type method.

Moreover, strong authentication of the user by the access management center 10 based on cryptographic means may also be used. For example, strong authentication may be based on a challenge and response protocol and a cryptographic mechanism using a public key.

In this case, the access management center 10 calculates a random number and sends it to the user's terminal 30 as a challenge. The terminal 30 then calculates a digital signature of the random number using a cryptographic signature private key and sends this response signature to the access management center 10. In turn, the access management center 10 verifies the signature using a cryptographic verification public key, and a positive verification result attests to the origin of the signature key and thus the identity of the user.

In a request, the user indicates the resource 25 to which the third party is to be authorized to access, for example by entering a predefined reference for the resource 25.

The access management center 10 verifies the existence of a correlation between the resource 25 and the user, for example by comparing the reference entered by the user to that indicated at the time of subscribing to the service.

Then, in a step E2, particular conditions governing the access authorization are defined by the user and/or the access management center 10.

For certain resources, and for security reasons or because of particular constraints, the access management center 10 may impose time periods or a set number of times for accessing the resource.

Of course, it is also possible for the user to define certain conditions within limits imposed by the access management center 10. For example, the access management center 10 may impose or define the access time period, whereas the user may define the date on which that time period starts.

It is also possible for particular conditions governing the access authorization to be defined entirely by the user, as in the above-mentioned example of access to the user's parking space.

These particular conditions governing the access authorization may include temporary access to the resource 25. Temporary access is then defined by a time period between two dates. The dates may be specified in the form year, month, day, hour, minute, or second. Temporary access may also be defined as a combination of time periods.

Furthermore, the particular conditions governing the access authorization may include one-off access, i.e. restricted access or access that is valid for only a few occasions. Access may also be defined as both temporary and one-off.

More generally, the particular conditions governing the access authorization may comprise parameters other than time or one-off parameters. For example, in the case of a data processing system, the resource may be divided into a plurality of access levels and in this case the particular conditions may govern access authorization in accordance with a certain hierarchy.

In a step E3, the user sends the access management center 10 the coordinates of the third party's mobile terminal 40. The mobile terminal 40 may be a mobile telephone, a personal digital assistant (PDA), or any other portable communications equipment.

Where applicable, the user indicates the identity and the coordinates of the third party, and where appropriate the means of authenticating the third party.

The user may define conditions that the third party must satisfy for access to be authorized.

Moreover, as a function of the required security level and the means available to the user, the access management center 10 may request the user to sign the various components of a request by cryptographic means, in particular the characteristics of the resource 25 to which the third party is to be granted access and the identity of the third party.

In response to the request from the user, in a step E4, the access management center 109 generates access data as a function of the components of the request, in particular as a function of the resource 25 and any particular conditions governing the access authorization.

The access management center 10 then contacts the third party's mobile terminal 40 by means of a connection L2, using the coordinates of the mobile terminal 40 communicated by the user, in order to send the access data to the third party's mobile terminal 40 in a step E5, so that the mobile terminal may be identified by the access control device 20 associated with the resource 25 in order to authorize access by the third party to that resource.

For added security, the third party may be authenticated by the access management center 10 before the access data is sent to the third party's mobile terminal 40.

The access management center 10 may request the third party to authenticate himself or herself, for example by entering a confidential code agreed beforehand with the user, who communicates the code to the access management center 10 at the time of the request. Having the code communicated to the user by the access management center 10 in order for the user in turn to communicate it to the third party may also be envisaged.

It will be noted that, depending on the required level of security, the third party may be authenticated by other means, for example by means of the third party's telephone number or the third party's electronic address, or by strong authentication based on cryptographic means.

When the third party is present in the vicinity of or in front of the access control device 20 associated with the resource 25, the third party is identified by the device using an access control protocol over a connection L3 between the mobile terminal 40 and the access control device 20.

The connection L3 between the third party's mobile terminal 40 and the access control device 20 is preferably a wireless radio connection (Bluetooth, WiFi, etc.), an infrared connection, or any other type of local transmission connection.

As a general rule, the access control device 20 includes a cryptographic mechanism consistent with the data that the access management center 10 sends to the third party's mobile terminal 40.

Where appropriate, using a connection L4 between itself and the access control device 20, the access management center 10 may verify if the control device is in a position to identify the access data sent to the third party's mobile terminal 40. For example, if the access control device 20 identifies the access data by cryptographic means, the access management center 10 checks that the access control device 20 has the necessary algorithms and cryptographic keys to perform the verification.

Having the parameters of the access control device 20 set by the access management center 10, in order to achieve consistency between the access control device 20 and the access data sent to the third party's mobile terminal 40, may also be envisaged. This parameter setting is preferably carried out before sending the access data to the third party's mobile terminal 40.

It will be noted that the connection L4 connects the access management center 10 to the access control device 20 by means of a landline or wireless telephone connection or, where applicable, by means of an Internet connection.

The method of the invention is then advantageous both for the user and for the third party.

This is because the user has a simple and secure way to provide a chosen third party with certain access facilities, providing merely that the third party has a mobile telephone.

For example, this is an easy way for a user to authorize invited guests to access a private car park if the car park has a remote-controlled access control device 20.

Another non-limiting example is that of a user away from home being able, if necessary, to lend his or her home “remotely” to a known third party without the necessity of arranging this beforehand, and without being obliged to delegate to some other person the physical handing over of gaining access. Of course, such access would be possible only to a home provided with an access control device 20 of the invention.

What is more, third parties receiving access rights thus have the benefit of easier authorization to access certain resources 25, at minimum effort. For example, guests may access a private car park without being obliged to get out of their car or to go anywhere to seek authorization to access the car park.

Moreover, the managers of certain controlled access resources 25 may circumvent the constraint represented by too great a number of occasional visitors to whom access must be provided.

An embodiment of the invention relating to guests of a user who are authorized to access a private car park is described below.

Mr X (the user), who is a subscriber to the service, is expecting guests for lunch, Mr and Mrs Y (the third parties). Mr X lives in an apartment in a building that has a private car park (the resource 25), to which Mr X wishes to give his guests temporary access.

Mr X then connects to the access management center 10 by dialing the number for communicating with the center on his fixed or mobile telephone. Mr X can also use Internet access to connect to the access management center 10.

Mr X identifies himself as a subscriber or user by authenticating himself by entering a confidential code previously established when he subscribed to the service. Given what is at stake, weak authentication is sufficient. It may even be envisaged that Mr X need only to prove that he belongs to a group of privileged users, for example the residents of the apartment building in which he lives and who subscribe to the service.

To deliver the right of access to a third party, Mr X indicates that he requires access to the appropriate service, for example by keying the number corresponding to that option when prompted by a voice menu. This specifies the characteristics of the resource, and where applicable any non-permanent conditions to be complied with, for example, single entry, this day, between 12h15 and 13h00.

Mr X also indicates a mobile telephone number for the third parties and where applicable the identity of Mr and/or Mrs Y, and specifies the required authentication mode. For example, in this situation the authentication mode might very well be imposed by the residents' committee of the apartment building.

Where appropriate the behavior of the access control device 20 associated with the automatic barrier (not shown) of Mr X's private car park may be configured or parameterized remotely by the access management center 10, using a connection dedicated to this purpose and a remote administration tool known in the art, to switch it into a configuration in which it accepts presentation of temporary access rights, such as are about to be presented by Mr and Mrs Y.

It will be noted that setting parameters is not necessary if the access control device 10 is disposed to accept any form of access rights, provided that the result of signature verification is positive.

The user's request is processed by the access management center 10, which contacts Mr and Mrs Y by dialing the number of their mobile telephone 40, as communicated by the user.

Where appropriate, the access management center 10 verifies their identity by prompting them to authenticate themselves by entering a confidential code agreed beforehand with Mr X, for example, and communicated by Mr X to the service by the means defined above. For example, a password previously communicated by Mr X could be more than sufficient.

The access management center 10 then delivers authorization to enter Mr X's private car park, in the form of a cryptographic signature, valid once only for this day, from 12h15 to 13h00, for example by sending an SMS message to their mobile telephone 40.

At 12h45, for example, Mr and Mrs Y present themselves before the access control device 20 associated with the automatic barrier of Mr X's private car park.

Mr and Mrs Y then present the access right that has previously been supplied to them, either by dialing a number of the access control device 20 or using communications means (IR, WiFi, contactless, etc.) authorized by their proximity to the access control device 20.

On positive verification of this right by a cryptographic verification mechanism included in the access control device 20, and on the conditions being satisfied, the barrier is raised to give them access to the car park.

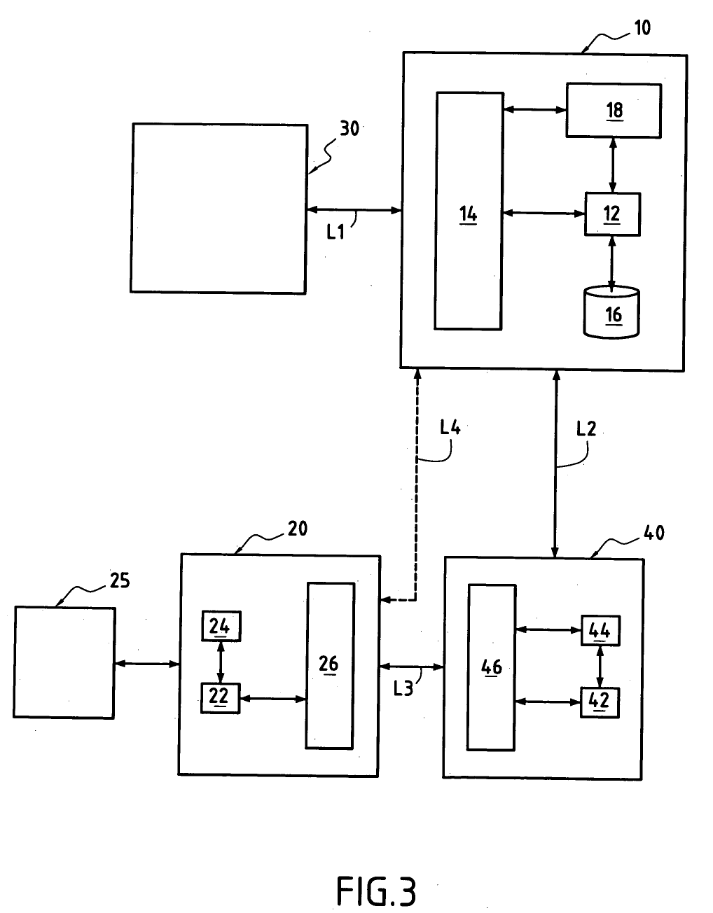

FIG. 3 is a highly diagrammatic view in more detail of an embodiment of a system of the invention for authorizing access to a resource.

The system comprises an access management center 10 and an access control device 20 associated with a resource 25.

The access management center 10 comprises a central processor unit 11 controlling a communications module 14 of the telephone or Internet type, one or more databases 16 relating to users, and an access rights generator module 18.

The communications module 14 is intended to receive a request from a user requesting granting of authorization to access a given resource to a third party equipped with a mobile terminal 40.

The database 16 contains the references of the user and the resource 25.

The central processor unit 12 is for processing user requests.

This central processor unit 12 comprises a computer management program comprising instruction codes necessary for the execution of a management step of the request from the user.

Finally, the generator module 18 is for creating access data as a function of the resource and any particular conditions governing access authorization.

The access control device 20 comprises a verification module 22 connected to an access delivery module 24 and to a wireless connection module 26.

Accordingly, when the communications module 14 of the access management center 10 receives a request emanating from the terminal 30 belonging to a user via the connection L1, the central processing unit 12 begins to process the request.

Initially, the central processor unit 12 may authenticate the user using the means envisaged.

For example, for authentication by means of a confidential code, the central unit 12 compares the code entered by the user with that stored in the database 16 at the time the user subscribed to the service.

For voice authentication, the central unit 12 compares the sample received with a sample stored in the database 16 at the time the user subscribed to the service.

For strong authentication based on cryptographic mechanisms, the central unit 12 dialogues with the user's terminal 30, for example using a challenge-response protocol.

The central unit 12 then proceeds to verify the consistency of the request.

For example, the central unit 12 verifies whether satisfying particular conditions set by the user is a realistic proposition.

The central unit also verifies whether the user has the right to make a request relating to the resource 25 referred to, by verifying in the databases 16 that the user is authorized to confer a right of access to the resource 25. It may also verify if the references of the third party benefiting from the access right are valid.

Where appropriate, the central unit 12 verifies the cryptographic signature of the request, to check its integrity. This guards against it being modified fraudulently during its progress from the user to the access management center 10.

The access management center 10 may then contact the access control device 20 (via the connection L4) to set its parameters or to verify whether it is already in a position to perform access control vis-à-vis the third party.

The central processing unit 12 then hands over to the access rights generator module 18, which creates access data to be sent to the third party's mobile terminal 40. The access data allows the use of an access control protocol between the third party's mobile terminal 40 and the access control device 20 for the purposes of identifying the third party.

If the third party must be identified by presenting a password, the generator module 18 creates access data associated with the password and with the particular conditions defining the access authorization in order for this data to be accepted by the access control device 20 concerned.

In the case of static authentication employing cryptographic signature verification, the generator module 18 creates access data in the form of a signature.

In the case of dynamic authentication employing cryptographic signature verification, if the third party's mobile terminal 40 has the necessary cryptographic computation capability, the generator module 18 creates access data in the form of a signature session key which is used to sign a random number supplied by the access control device 20 to the third party's mobile terminal 40.

The access data is then sent to the third party's mobile terminal 40 by the communications module 14 of the access management center 10.

Generally speaking, a mobile terminal 40 comprises a control module 42, a storage module 44 and a wireless connection module 46.

The access data received by the third party's mobile terminal 40 is stored in the storage module 44.

Accordingly, when the mobile terminal 40 is communicating with the access control device 20, the control module 42 of the module terminal 40 controls the storage module 44 and the wireless connection module 46 so that the access data is presented to the access control device 20 over the connection L3.

The control module 42 of the module terminal 40 comprises a computer processing program comprising instruction codes necessary for the execution of a management step of the storage and the wireless connection modules 44, 46 for presenting an access data to the access control device 20.

When the connection module 26 of the access control device 20 connects to the mobile terminal 40, the verification module 22 verifies the access data presented by the mobile terminal 40. If the verification result is satisfactory, the access delivery module 24 of the access control device 20 delivers to the third party an authorization to access the resource 25. For example, if the given resource 25 is a parking garage, the access delivery module actuates a motor to open the barrier or the door thereof.

The access control device 20 comprises a computer control program comprising instruction codes necessary for the execution of a verification step of the access data presented by the mobile terminal 40, for delivering access to the resource 25.

1. A method of granting authorization to access a resource, the method comprising the following steps:
connecting a user to an access management center to request that authorization to access a given resource be granted to a third party equipped with a mobile terminal,
defining particular conditions governing the access authorization,
the user sending coordinates of the third party's mobile terminal to the access management center,
the access management center generating access data as a function of the resource and said particular conditions, and
sending said access data to the third party's mobile terminal to enable the latter to be identified by an access control device associated with said resource in order to authorize the third party to access that resource.

2. A method according to claim 1, wherein the particular conditions governing the access authorization include temporary access to the resource.

3. A method according to claim 1, wherein the particular conditions governing the access authorization include one-off access to the resource.

4. A method according to claim 1, wherein the connection of the user to the access management center includes authentication of the user by said access management center.

5. A method according to claim 1, wherein the connection of the user to the access management center includes verification by the access management center of a correlation between the resource and the user.

6. A method according to claim 1, further comprising verification by the access management center of the fact that the access control device is able to identify the access data sent to the third party's mobile terminal.

7. A method according to claim 1, wherein the access control device identifies the access data by cryptographic means.

8. A method according to claim 1, further comprising the access management center setting parameters of the access control device in order to establish consistency between the access control device and the access data sent to the third party's mobile terminal.

9. A method according to claim 1, further comprising authentication of the third party by the access management center before sending access data to the third party's mobile terminal.

10. A method according to claim 1, wherein identification of the third party by the access control device uses an access control protocol over a connection between the mobile terminal and the access control device.

11. A system for granting authorization to access a resource, the system comprising:
an access management center for managing a request sent by a user requesting that authorization to access a given resource be granted to a third party equipped with a mobile terminal, the access authorization being governed by particular conditions, and
an access control device associated with said resource for identifying access data on the third party's mobile terminal in order to authorize access of the third party to the resource, said access data being generated by the access management center and sent by that center to the third party's mobile terminal.

12. A system according to claim 11, wherein the access control device comprises a cryptographic means for identifying the access data.

13. An access management center comprising:
a communications module adapted to receive a request from a user requesting that authorization to access a given resource be granted to a third party equipped with a mobile terminal,
a database containing references of the user and the resource,
a central processing unit adapted to manage the request from the user, and
a generator module adapted to create access data as a function of the resource and particular conditions governing the access authorization.

14. An access control device comprising:
a connection module adapted to connect to a mobile terminal,
a verification module adapted to verify access data presented by the mobile terminal, and
a delivery module adapted to deliver access to a resource if the result of the verification effected by the verification module is satisfactory.

15. A mobile terminal comprising a control module controlling a storage module and a wireless connection module for presenting an access data, received from the access management center according to claim 13, to an access control device.

16. Computer management program ready to be implemented in the access management center according to claim 13, wherein said program comprises instruction codes for the execution of a management step of the request from the user when said program is executed by the access management center.

17. Computer control program ready to be implemented in the access control device according to claim 14, wherein said program comprises instruction codes for the execution of a step of verification of the access data presented by the mobile terminal, for delivering access to a resource when said program is executed by the access control device.

18. Computer processing program ready to be implemented in the control module of the mobile terminal according to claim 15, wherein said program comprises instruction codes for the execution of a management step of the storage and the wireless connection modules for presenting an access data to the access control device when said program is executed by the control module of the mobile terminal.
